(19) United States
(12) Patent Application Publication
(10) Pub. No.: US 2001/0039513 A1
(43) Pub. Date: Nov. 8, 2001

(54) Automated online sweepstakes system and method

(76) Inventors: Andrew A. Erlichson, Metuchen, NJ (US); Mark A. Heinrich, Ithaca, NY (US); Gregory P. Coladonato, San Francisco, CA (US); Jonathan G.T. Bailey, Brooklyn, NY (US)

Correspondence Address: Bradley J. Meier, KENYON & KENYON, Suite 700, 1500 K Street, N.W., Washington, DC, 20005, US

(21) Appl. No.: 09/775,504

(22) Filed: Feb. 5, 2001

Related U.S. Application Data
(60) Provisional application No. 60/180,020, filed on Feb. 3, 2000.

(51) Int. Cl. G06F 17/60

(52) U.S. Cl. 705/14

(57) ABSTRACT

An automated process of conducting an online sweepstakes and marketing to sweepstakes entrants. The software system enables a non-technical individual (e.g., sweepstakes manager, marketer, etc.) to create a sweepstakes entry form that is integrated with back-end data processing systems. The entry form and entry form processing system are kept consistent with sweepstakes rules chosen by the non-technical individual and automatically generated by the system. The system enforces compliance with applicable laws with integrated tools to pick winners, to determine eligibility and to collect winner affidavits. A back-end database is integrated directly with a sweepstakes entry form. Online tools permit a marketer to view entrants and select entrants to receive direct email. Direct-email marketing tools are integrated with the sweepstakes front-end system, which allows a marketer to send out promotional offers and business communications directly from the sweepstakes system.

### CROSS-REFERENCE TO RELATED APPLICATION

This application claims the benefit under 35 U.S.C. §119(e) of U.S. Provisional Application No. 60/180,020, filed Feb. 3, 2000.

### FIELD OF THE INVENTION

The present invention relates to the ability to build and manage an online sweepstakes with full automation.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND INFORMATION

Marketers have traditionally run sweepstakes to draw attention among consumers to a product or company. If a sweepstakes is run by a “brick and mortar” store, the goal is to increase foot traffic to the store. If a sweepstakes is run as part of a direct-mail promotion, the goal is to increase consumer interest in the mailing. In the United States, a sweepstakes may be defined as any game that offers the element of chance to win a prize without the element of consideration to play the game. Consideration is a legally defined term referring, broadly speaking, to something of value exchanged for something else of value. The presence of consideration paid by the consumer to the sweepstakes organizer makes the game a form of gambling. To avoid being regulated as gambling, all sweepstakes follow the common form of offering a prize to the winner but not requiring purchase on the part of the consumer.

Sweepstakes are also conducted over computer networks, most typically over the Internet. In an Internet, or online, sweepstakes, consumers enter the sweepstakes through electronic entry forms. These entries forms are often available on Web sites and advertised both on and off the Internet. Internet-based sweepstakes afford the marketer the opportunity to do more than draw consumer traffic. A marketer can also control the contact information provided by the consumer, typically an email address, and use that contact information to send marketing materials directly to the consumer. A well-designed sweepstakes offers a prize that tends to attract consumers who would also be interested in the sweepstakes organizer's products or services. For example, a coffee company might run a sweepstakes offering free coffee for life since consumers who enter such a sweepstakes are presumably interested in coffee. With a well-designed sweepstakes, the sweepstakes entrants are good prospects for the products and services of the sweepstakes organizer.

Sweepstakes are regulated by the states and by most other countries. To run a legal sweepstakes, the sweepstakes organizer must abide by all applicable regulations and conventions. For example, rules must be clearly posted, no purchase can be required of the consumer to enter, and laws regarding bonding and registration must be followed. Coordinating the different elements of the sweepstakes so that they are all self-consistent is difficult and typically requires the help of a promotions agency.

Running a sweepstakes online poses the additional challenge of designing the online entry form and the back-end processes that will take online entries and store them in a database. Programming a system to take entries and enforce the posted rules is difficult, often requiring custom programming by trained software engineers. And the process of marketing to sweepstakes entrants usually entails the export of the entrant data, the import of the entrant data to a different system and the conducting of direct-email marketing campaigns manually.

Accordingly, there is a need in the art for a method and system of building and managing an online sweepstakes with full automation. There is a need for integrating direct email marketing tools directly with an online sweepstakes, since the costs of sending email on the Internet are very low and the entrants to a sweepstakes are good customer prospects. These tools would permit a marketer to send out offers via email to entrants that satisfy certain criteria, and the tools would also allow the marketer to track responses to those offers.

### SUMMARY OF THE INVENTION

The present invention automates the process of conducting an online sweepstakes and marketing to sweepstakes entrants. The software system enables a non-technical individual (e.g., sweepstakes manager, marketer, etc.) to create a sweepstakes entry form that is integrated with back-end data processing systems. The entry form and entry form processing system are kept consistent with sweepstakes rules chosen by the non-technical individual and automatically generated by the system. The system enforces compliance with applicable laws with integrated tools to pick winners, determine eligibility and collect winner affidavits.

The invention integrates a back-end database directly with a sweepstakes entry form. Online tools permit a marketer to view entrants and select entrants to receive direct email. The invention also integrates direct-email marketing tools with the sweepstakes front-end system, which allows a marketer to send out promotional offers and business communications directly from the sweepstakes system.

### BRIEF DESCRIPTION OF THE DRAWINGS

FIG. 1 is a block diagram depicting the internal structure of a client computing device in accordance with an exemplary embodiment of the present invention.

FIG. 2 is a block diagram depicting a network architecture for an online sweepstakes in accordance with an exemplary embodiment of the present invention.

FIG. 3 is a block diagram of the logical components of an online sweepstakes in accordance with an exemplary embodiment of the present invention.

FIG. 4 is a flow chart of steps for building, managing and using an online sweepstakes in accordance with an exemplary embodiment of the present invention.

FIG. 5 is a screen shot of a form for creating an online sweepstakes in accordance with an exemplary embodiment of the present invention.

FIG. 6 is a screen shot of a form for specifying drawings and prizes in an online sweepstakes in accordance with an exemplary embodiment of the present invention.

FIG. 7 is a screen shot of a form for specifying rules in an online sweepstakes in accordance with an exemplary embodiment of the present invention.

FIG. 8 is a screen shot of a form that allows content of an online sweepstakes to be edited in accordance with an exemplary embodiment of the present invention.

FIG. 9 is a screen shot of automatically generated sweepstakes rules in accordance with an exemplary embodiment of the present invention.

FIG. 10 is a screen shot of an automatically generated online sweepstakes entry form in accordance with an exemplary embodiment of the present invention.

FIG. 11 is a screen shot of online sweepstakes management options and entrant database tools in accordance with an exemplary embodiment of the present invention.

FIG. 12 is a screen shot of a winner-drawing tool of an online sweepstakes in accordance with an exemplary embodiment of the present invention.

FIG. 13 is a screen shot of an announcement email sent to winners of an online sweepstakes in accordance with an exemplary embodiment of the present invention.

FIG. 14 is a screen shot of an affidavit response form in an online sweepstakes in accordance with an exemplary embodiment of the present invention.

FIG. 15 is a screen shot of a submitted affidavit from an online sweepstakes winner, along with tools for managing winners, in accordance with an exemplary embodiment of the present invention.

FIG. 16 is a screen shot of entrants in an online sweepstakes in accordance with an exemplary embodiment of the present invention.

FIG. 17 is a screen shot of click reporting of entrants of an online sweepstakes in accordance with an exemplary embodiment of the present invention.

### DETAILED DESCRIPTION

### INFRASTRUCTURE

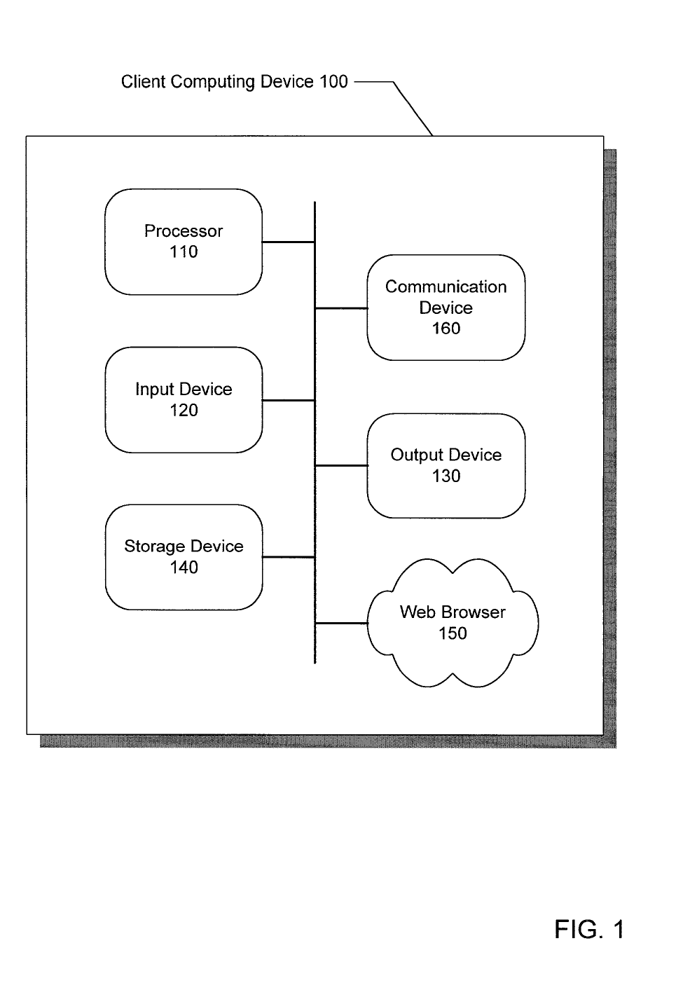

FIG. 1 is a block diagram depicting the internal structure of client computing device 100 in accordance with an exemplary embodiment of the present invention. Client computing device 100 may be a personal computer, handheld personal digital assistant (“PDA”), or any other type of microprocessor-based device. Client computing device 100 may include a processor 110, input device 120, output device 130, storage device 140, Web browser 150, and communication device 160. Input device 120 may include a keyboard, mouse, pen-operated touch screen, voice-recognition device, or any other device that provides input from a user. Output device 130 may include a monitor, printer, disk drive, speakers, or any other device that provides tangible output to user. Storage device 140 may include volatile and nonvolatile data storage. Volatile data storage includes RAM, a cache, or any storage medium that temporarily holds data while being processed; nonvolatile data storage includes a hard drive, CD-ROM drive, tape drive, removable storage disk, or any other non-temporary storage medium. Communication device 160 may include a modem, network interface card, or any other device capable of transmitting and receiving signals over a network. Web browser 150 may be executed by processor 110 and may include Internet Explorer(TM) by Microsoft(TM) or Communicator(TM) by Netscape(TM), or any other software program that displays data from a Web server to a user via output device 130. One skilled in the art would appreciate that the components of client computing device 100 may also be connected wirelessly, possibly through an infrared connection.

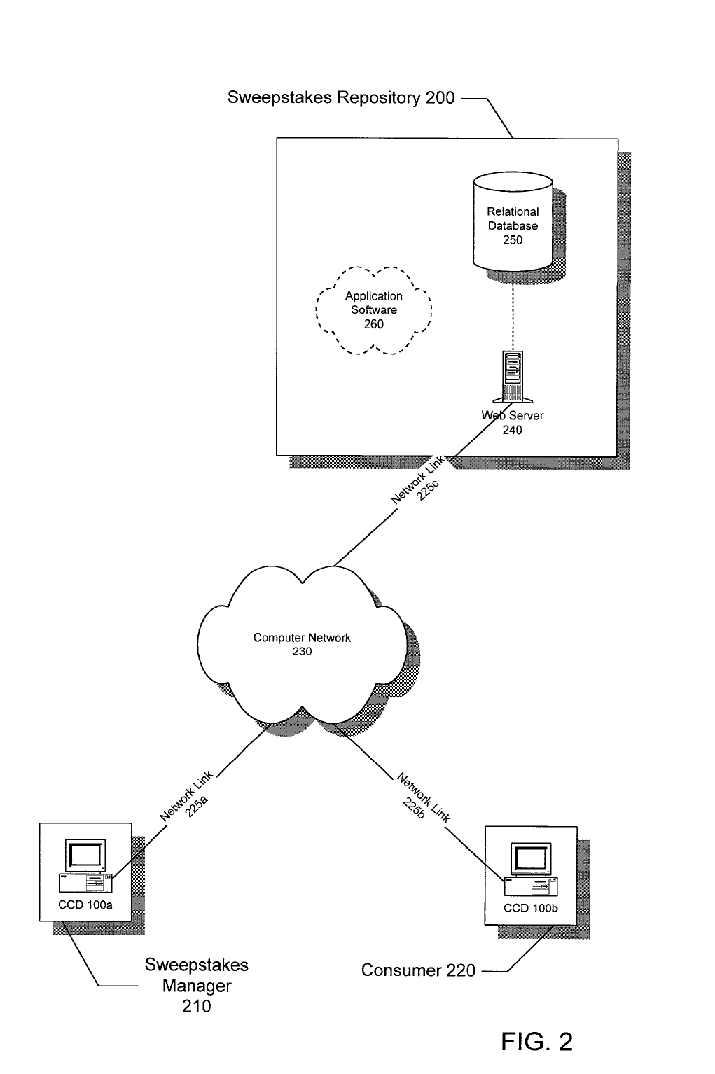

FIG. 2 is a block diagram depicting a network architecture for an online sweepstakes in accordance with an exemplary embodiment of the present invention. According to one embodiment, when consumer 220 participates in an online sweepstakes from sweepstakes repository 200, client computing device 100b sends and receives via Web browser 150 HTTP (“Hypertext Transport Protocol”) requests (or any similar protocol requests) to and from Web server 240 via network link 225b, computer network 230, and network link 225c. Similarly, when sweepstakes manager 210 participates in an online sweepstakes from sweepstakes repository 200, client computing device 100a sends and receives via Web browser 150 HTTP requests to and from Web server 240 via network link 225a, computer network 230, and network link 225c. Application software 260, running on Web server 240, contains the logic of the sweepstakes system of the present invention, and stores and retrieves information relating to consumers and sweepstakes in relational database 250.

Network link 225 may include telephone lines, DSL, cable networks, T1 or T3 lines, wireless network connections, or any other arrangement that provides a medium for the transmission and reception of computer network signals. Computer network 230 may include a wide-area network (“WAN”), such as the Internet, or a local-area network (“LAN”), such as an intranet. It should be noted that, technically, client computing device 100, network link 225, Web server 240 and any intermediate network components, such as Internet service providers and routers (not shown), are also part of computer network 230 because of their connectivity. Computer network 230 may implement any number of communications protocols, including TCP/IP (“Transmission Control Protocol/Internet Protocol”). The communication between CCD 100a, CCD 100b and Web server 240 may be secured by any Internet security protocol, such as Secured Sockets Layer (“SSL”).

Web server 240 includes a processor and memory for executing program instructions, as well as a network interface (not shown), and may include a collection of Web servers working in tandem to distribute the load of network traffic. Web server 240 runs an HTTP server program in one embodiment, such as Apache(TM), as a process under an operating system such as UNIX(TM), or any variant thereof. Relational database 250 may be part of a relational database program, such as MySQL(TM) or Oracle(TM), that may be run as a process by a separate database server (not shown) within the UNIX(TM) operating system, for example. Application software 260 may take the form of custom-written programs and libraries that run, either interpreted or compiled, as a result of HTTP requests received by Web server 240. These programs may be written in any programming language, such as C, C++, or PERL (“Practical Extraction and Reporting Language”), and they may generate the HTML (“Hypertext Markup Language”) interface of the online sweepstakes system.

One skilled in the art will see that although this embodiment of the invention is functional, other equally attractive alternatives exist. Other variations include but are not limited to running a database server process on Web server 240, splitting application software 260 to run on multiple database servers, and using object-based rather than relational-based database systems. In addition, one skilled in the art may see that several performance optimizations are possible including but not limited to caching data on Web server 240, introducing a middle tier of computers to run as application servers with system state, replacing the relational database system with a full-custom program that implements the necessary state management, and caching system objects closer to consumers and sweepstakes managers.

### ONLINE SWEEPSTAKES COMPONENTS

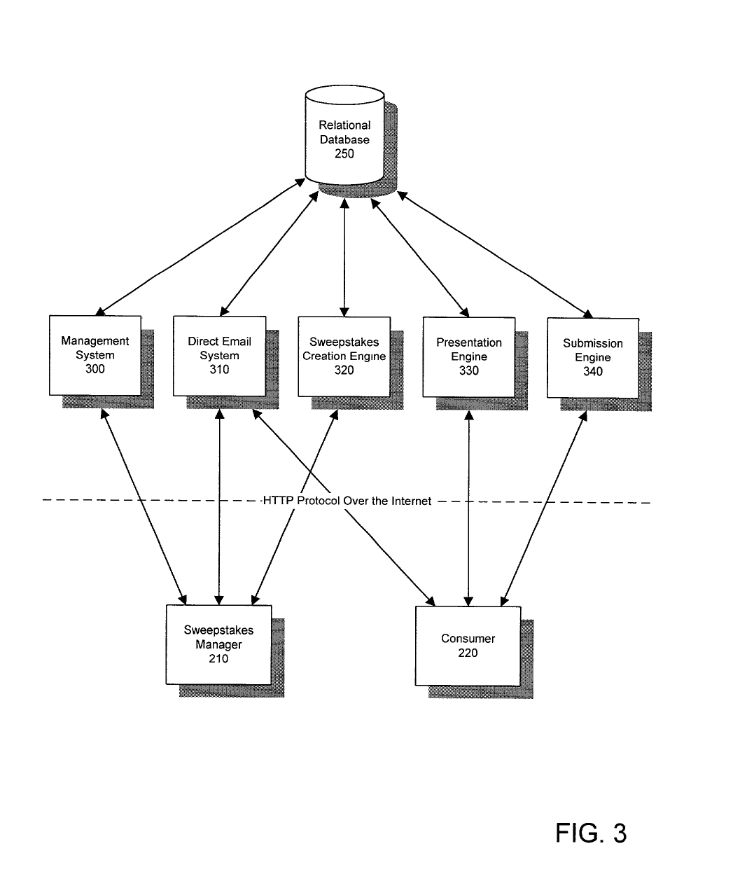

FIG. 3 is a block diagram of the logical components of an online sweepstakes in accordance with an exemplary embodiment of the present invention. As embodied in application software 260, the row of components comprising management system 300, direct email system 310, sweepstakes creation engine 320, presentation engine 330, and submission engine 340 make up the front-end of the sweepstakes system that interacts with sweepstakes manager 210 and consumer 220. Relational database 250 is the back-end of the sweepstakes system that stores all relevant information. The two-way arrows in FIG. 3 demonstrate the logical connections between the various components.

For example, sweepstakes manager 210, who may also be a marketer, interacts with sweepstakes creation engine 320 to design the sweepstakes, including the entry form, prizes and entry deadlines. Sweepstakes creation Engine 320 stores information about the sweepstakes in relational database 250. Once the sweepstakes has begun, consumer 220, using Web browser 150, enters the sweepstakes by requesting the sweepstakes entry form from presentation engine 330. Presentation engine 330 requests information about the sweepstakes from relational database 250 and converts that information into a page suitable for presentation on consumer 220's Web browser 150. In one embodiment consumer 220 is using an HTML-compliant Web browser and presentation engine 330 converts the logical description of the sweepstakes directly to HTML. Consumer 220 fills out the entry form electronically and submits the entry form back to submission Engine 340. Submission engine 340 checks the data submitted by consumer 220 against a set of rules deduced from the logical database description of the sweepstakes. If the entry form is properly completed, consumer 220 is entered into the sweepstakes and the entry is entered into relational database 250. Otherwise the entry is rejected.

At any time after the sweepstakes launches, the marketer can search for entrants or contestants in relational database 250 and send out email to selected entrants via direct email system 310. Direct email system 310 collects lists of email addresses from relational database 250 and sends mail directly to those entrants under the direction of the marketer. Management system 300 includes tools that enable the marketer or sweepstakes manager 210 to pick winners, track prize fulfillment and verify the eligibility of entrants. Management system 300 also generates a set of sweepstakes rules dynamically based on the choices that the marketer or sweepstakes manager 210 makes during the creation process.

### USING ONLINE SWEEPSTAKES

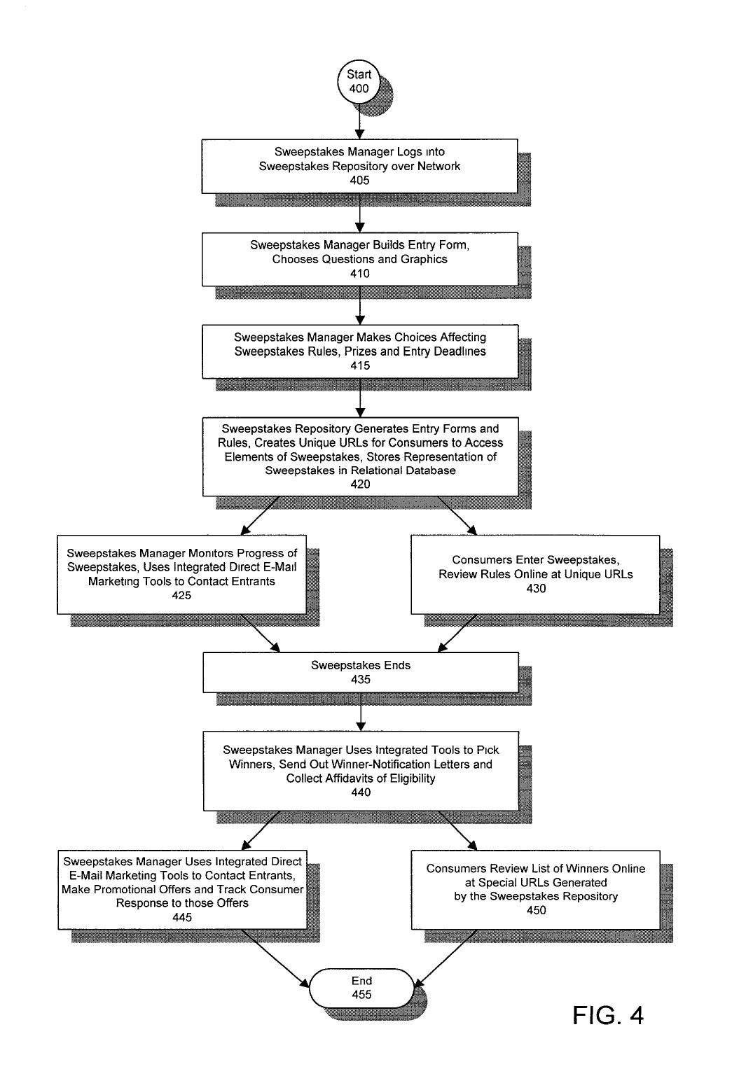

FIG. 4 is a flow chart of steps for building, managing and using an online sweepstakes in accordance with an exemplary embodiment of the present invention. The method starts (step 400) with sweepstakes manager 210 logging into sweepstakes repository 200 over computer network 230 (step 405). Once logged in, sweepstakes manager 210 interacts with sweepstakes repository 200 to build a sweepstakes (step 410). Sweepstakes manager 210 designs the entry form, deciding what questions to ask and what graphics to display. Sweepstakes manager 210 specifies prizes and entry deadlines (step 415) along with other aspects of the sweepstakes that affect the rules. Sweepstakes repository 200 guides sweepstakes manager 210 through the process interactively. Once the sweepstakes has been completely defined, sweepstakes repository 200 generates unique entry forms and a unique set of rules (step 420) customized for this sweepstakes. For example, if the name of the sweepstakes is “Enter to Win a Trip to Paris,” then sweepstakes repository 200 may create a unique URL including the filename “triptoparis” to accept entries. Sweepstakes repository 200 also stores a representation of the sweepstakes in relational database 250.

Entrants (e.g., consumers 220) can enter the sweepstakes (step 430) online once it has been fully created. Concurrently, sweepstakes manager 210 can monitor the progress of the sweepstakes (step 425), reviewing entrant statistics and usage patterns. Sweepstakes manager 210 can also use integrated direct marketing email tools while the sweepstakes is in progress, since the entrant data resides within the same system as the direct email system. It is beneficial to be able to contact participants early, while the sweepstakes is still fresh in their minds.

Once the sweepstakes has ended (step 435), entrants can no longer submit entry forms. Sweepstakes manager 210 then uses integrated winner-drawing tools (step 440) to randomly choose winners that conform to the rules of the sweepstakes. For example, if the sweepstakes has three drawings set out over nine weeks, then sweepstakes repository 200 may force the manager to pick the winners for the earlier drawing first, conforming to the rules. Sweepstakes repository 200 also provides tools to send out letters via email to winners notifying them that they have won, along with tools to collect online affidavits of eligibility. Sweepstakes repository 200 also tracks who has received a prize so that sweepstakes manager 210 may conform to the rules, awarding all prizes necessary. From the list of winners, sweepstakes repository 200 prepares unique URLS containing lists of winners so that consumers 220 can discover who won the sweepstakes, a common requirement of the States (step 450).

Sweepstakes manager 210, or another marketing representative of that manager, can use the integrated direct email marketing tools (step 445) at the completion of the sweepstakes to contact consumers 220 with promotional offers or other communications. Sweepstakes repository 200 provides tools for composing offers, sending out those offers and tracking consumer response rates.

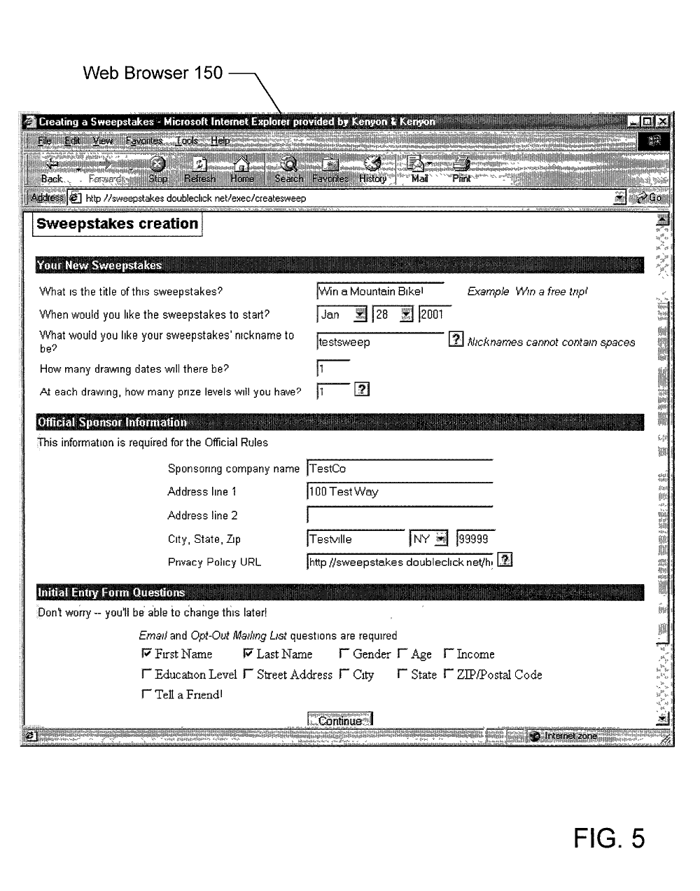

FIGS. 5-17 are screen shots illustrating the steps described above via Web browser 150 (in this case, Internet Explorer(TM)) in accordance with an exemplary embodiment of the present invention.

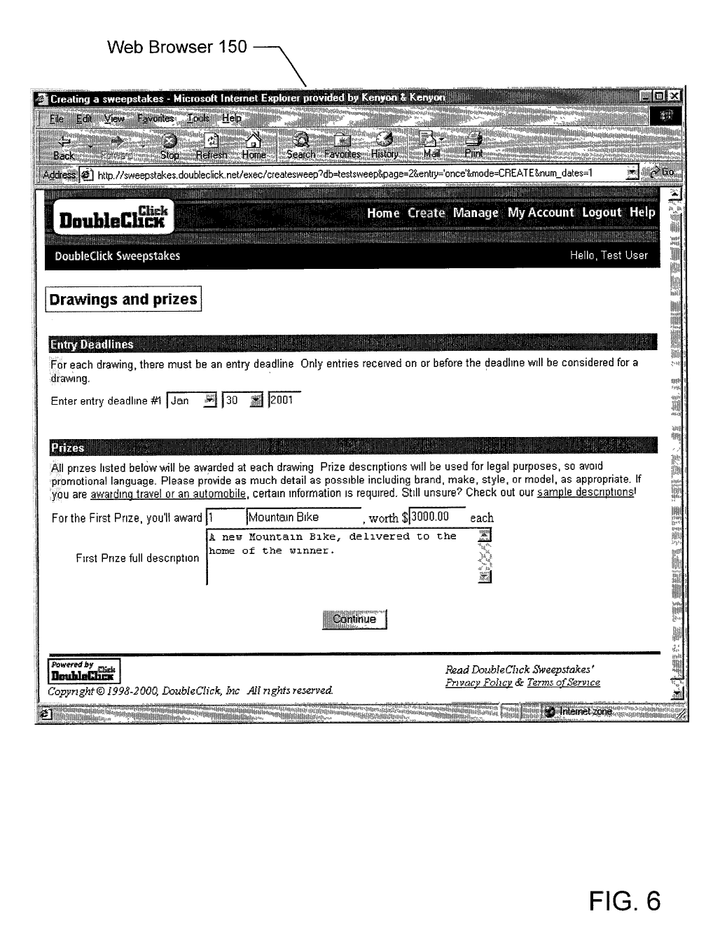

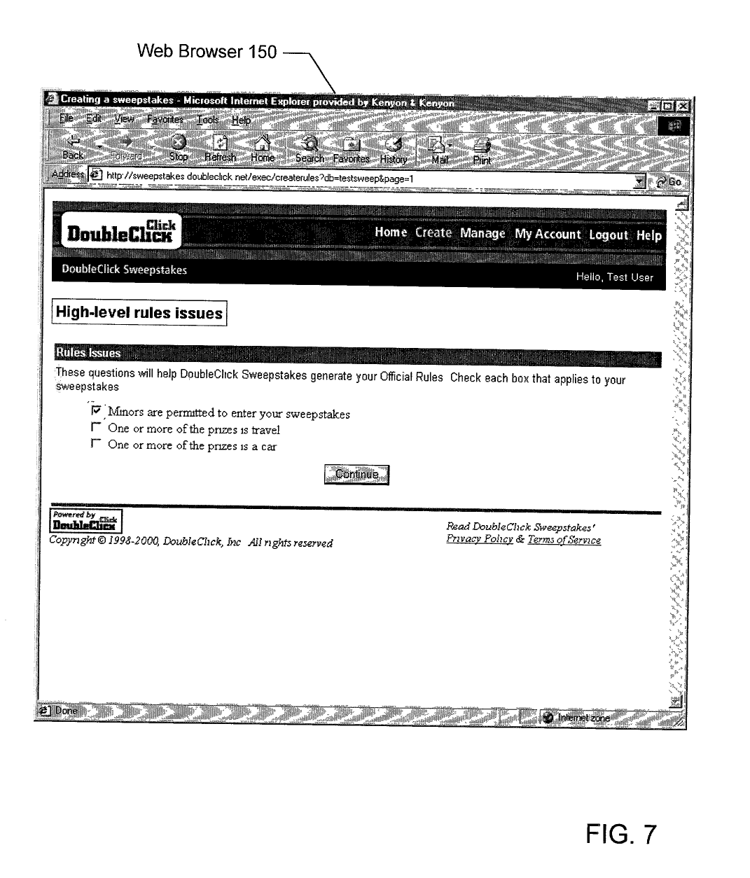

FIGS. 5-10 illustrate the method of building a custom sweepstakes. In FIG. 5, sweepstakes manager 210 enters information in Web browser 150 such as sweepstakes details (e.g., title of sweepstakes, when it starts, number of drawing dates and prizes), sponsor information and initial entry form questions. Based on the checked boxes at the bottom of the screen, sweepstakes manager 210 has chosen the entry form to solicit the first and last name of the entrant (i.e., consumer 220). FIG. 6 shows that sweepstakes manager 210 will award a mountain bike at the close of the drawing, which is entered as Jan. 30, 2001. In FIG. 7, sweepstakes manager 210 chooses certain rules that will apply to the sweepstakes, such as the participation of minors. The checked box indicates that minors are allowed to enter this sweepstakes.

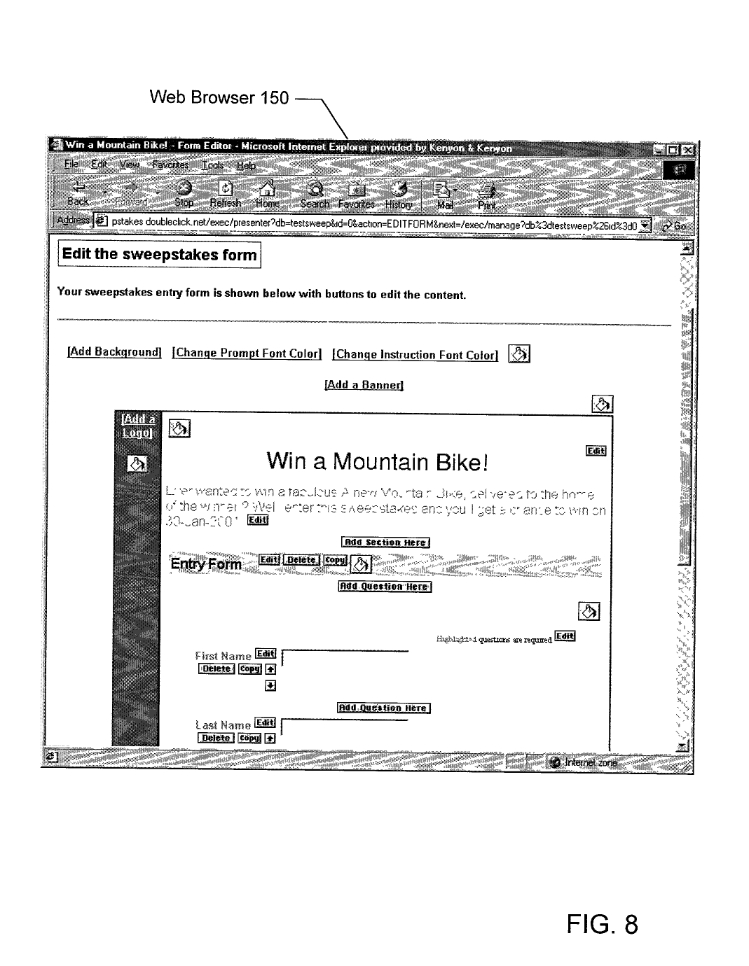

FIG. 8 allows sweepstakes manager to design the sweepstakes entry form online and at a high level. By selecting the various editing buttons (such as those labeled “Edit”, “Delete” and “Copy”), sweepstakes manager 210 is presented a prompt that allows sweepstakes manager 210 to specify various question attributes. This prompt could take many forms, such as a small pop-up window or a separate Web page. These question attributes can include, among others, the question to be presented to the entrant on the sweepstakes entry form, the maximum permissible length of an entrant response in characters, whether a question to be presented to an entrant begins on a new line in the sweepstakes entry form, an instruction field associated with a question, and the type of question to be presented to the entrant. Some common types of questions are multiple choice, check-all-that-apply (i.e., radio buttons), and fill-in-the-blank. Once these attributes have been specified, application software 260 is able to generate an HTML form consistent with the inputted attributes, and stores this information in relational database 250.

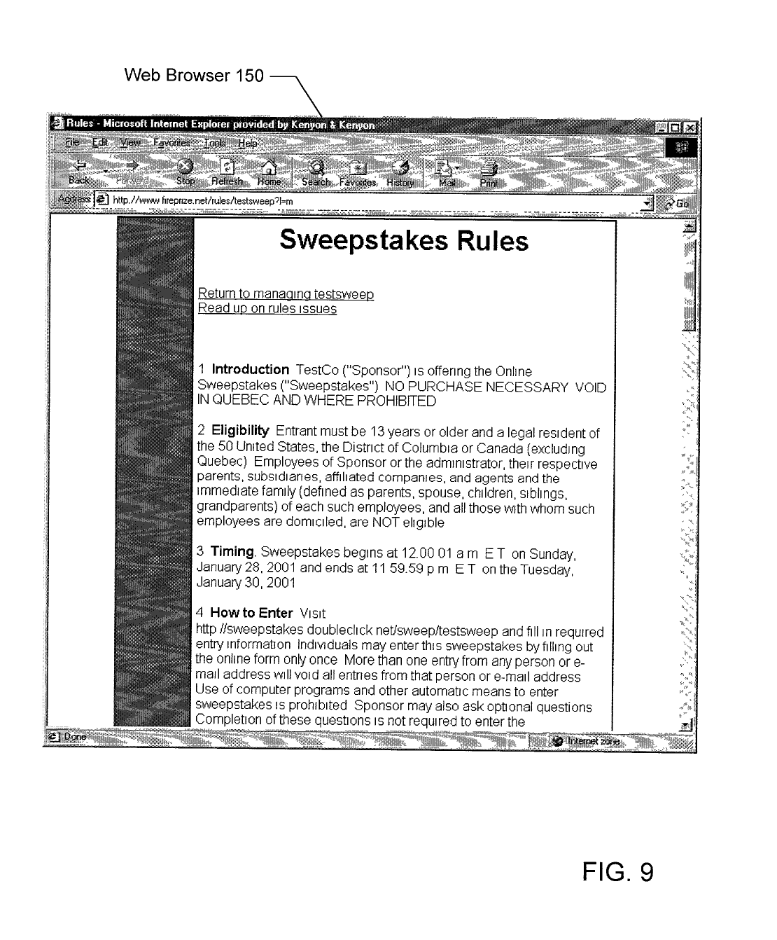

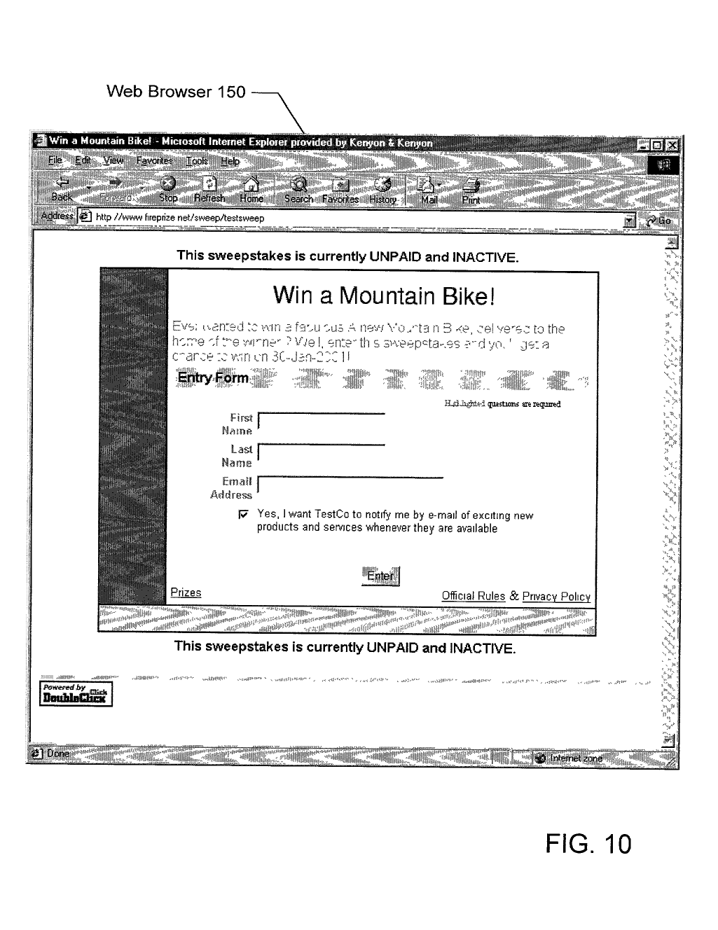

As shown in FIG. 9, application software 260 automatically generates a set of rules for the contest with regard to laws in the various countries, states and provinces where the contest will be available. Rules are customized with respect to the specific sweepstakes parameters chosen by sweepstakes manager 210 in previous screens. For example, since minors are permitted to enter, one can see that paragraph 2 of the rules states that entrants “must be 13 years or older.” Application software 260 imposes contest rules on all contestants, assuring that entries are only accepted during legal periods. FIG. 10 depicts the online entry form generated by application software 260, which is available on computer network 230 at a URL specified by sweepstakes repository 200.

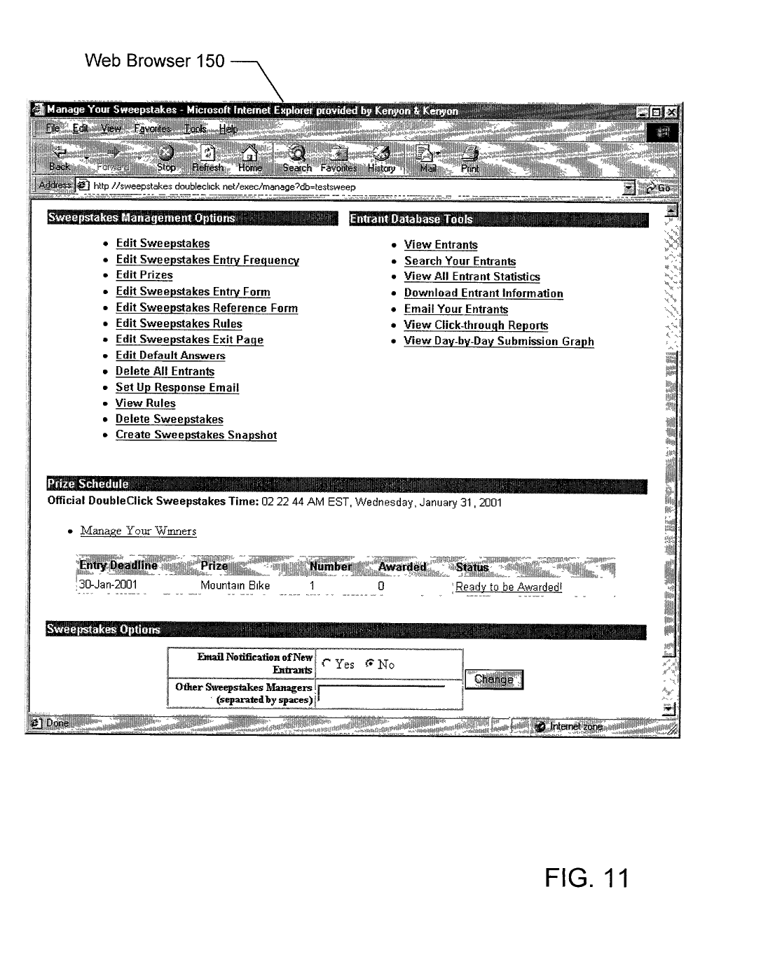

FIGS. 11-14 illustrate the method of awarding a sweepstakes winner. FIG. 11 depicts the screen that notifies sweepstakes manager 210 that the mountain bike sweepstakes is ready to be awarded. This status is indicated under the section labeled “Prize Schedule.” One notices that the official sweepstakes time is Jan. 31, 2001, which is one day after the mountain bike sweepstakes was scheduled to end. Official sweepstakes time in this embodiment is maintained by sweepstakes repository 200. FIG. 11 also displays the various sweepstakes management options and entrant database tools.

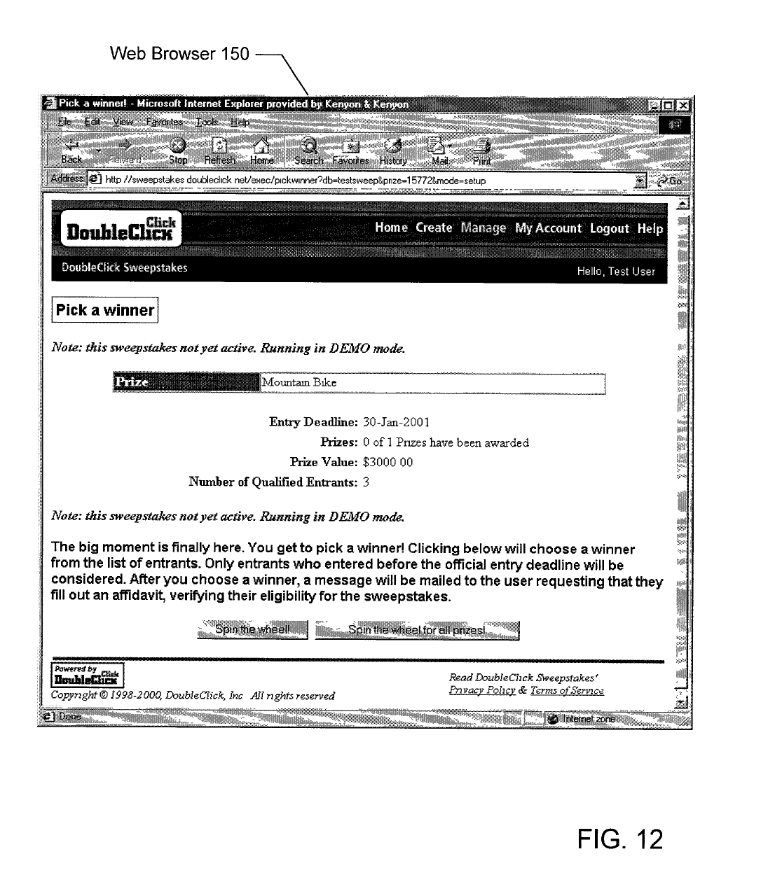

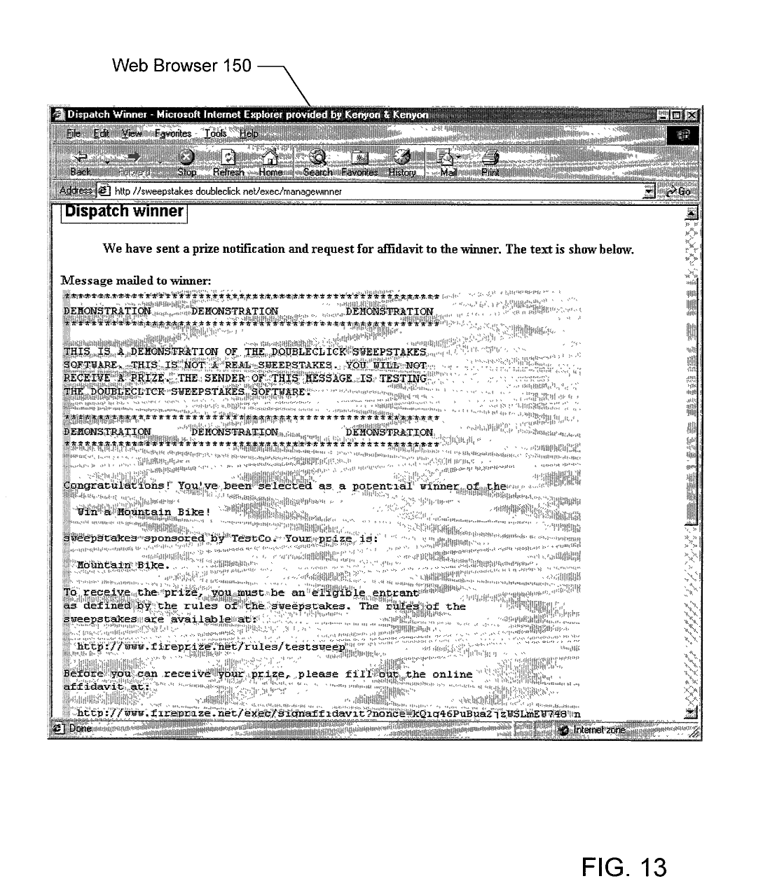

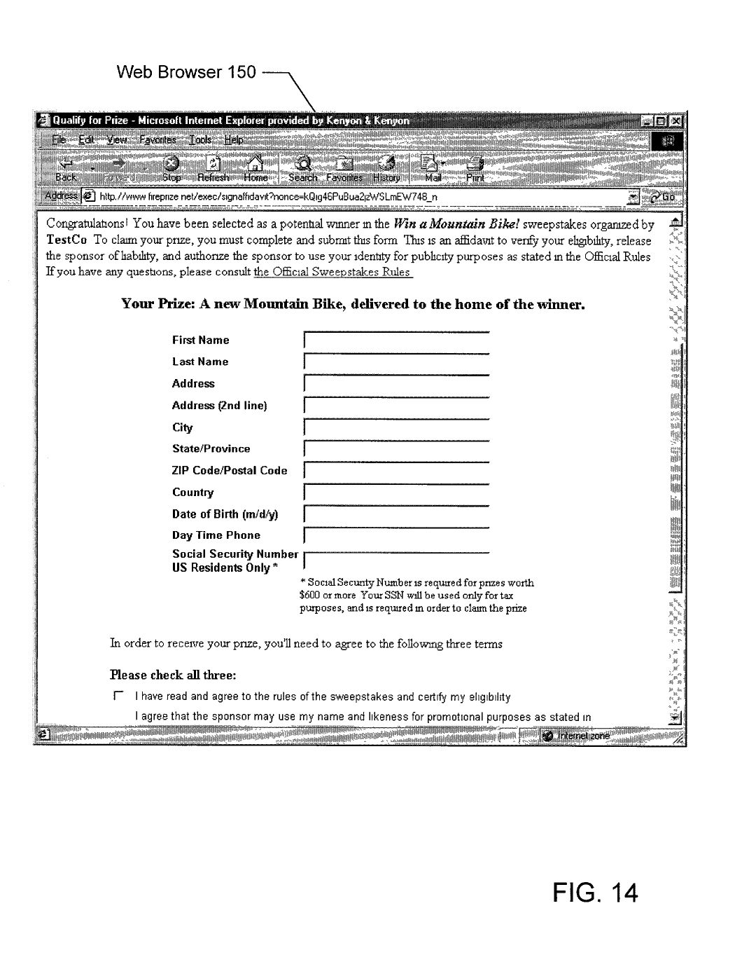

Upon clicking on the status link labeled “Ready to be Awarded!” in FIG. 11, sweepstakes manager 210 is presented with the winner-drawing tool as shown in FIG. 12. Upon clicking the “Spin the Wheel!” button at the bottom of the screen, application software 260 randomly selects an associated contestant to be the winner, and generates an electronic affidavit for the winner in order to verify eligibility. The potential winner receives email with an announcement of their selection and a link on computer network 230 to complete the affidavit online. FIG. 13 shows the text of the announcement e-mail. FIG. 14 displays the affidavit response screen that the potential winner accesses in order to verify eligibility.

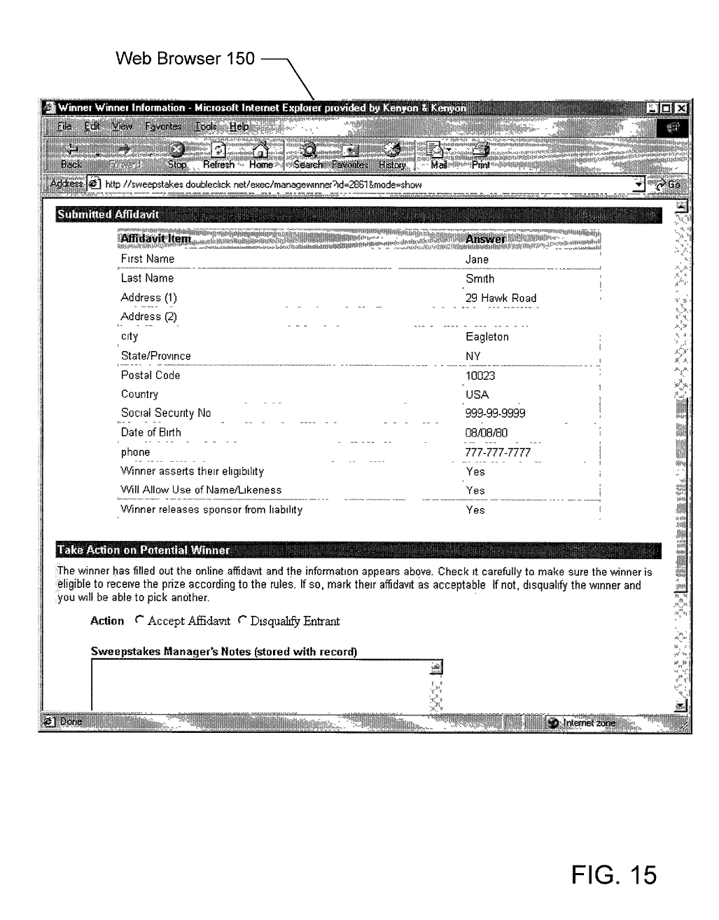

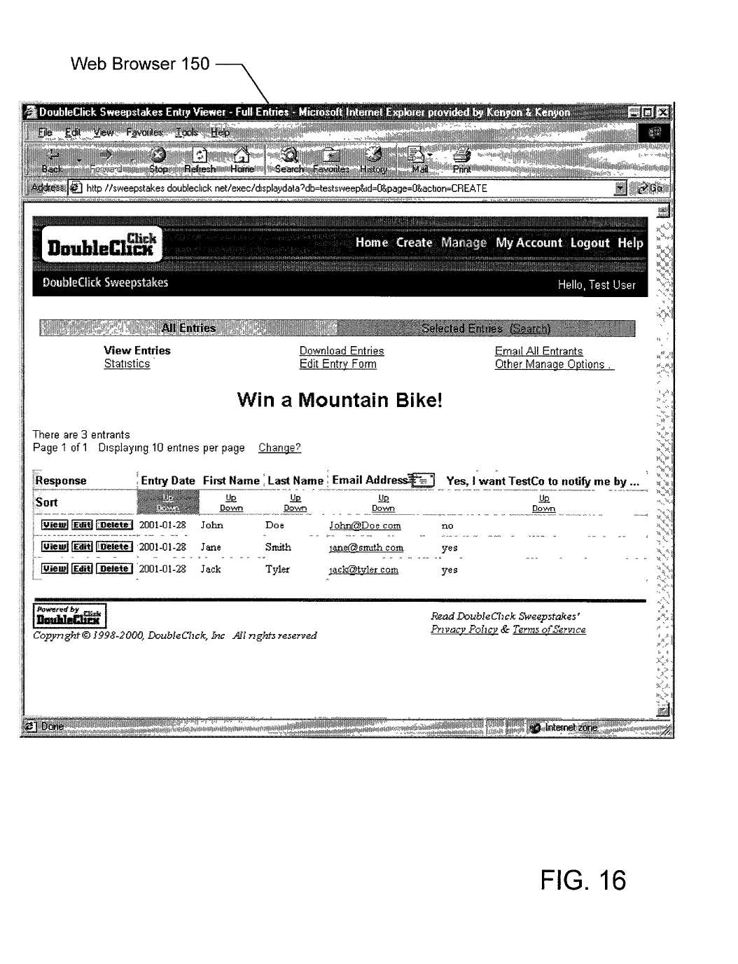

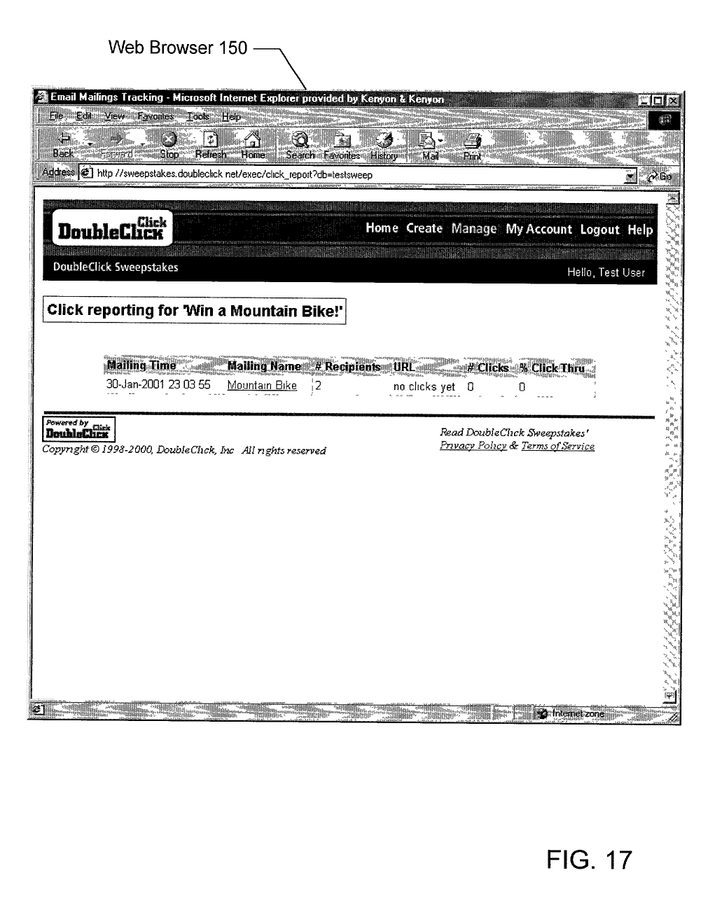

FIGS. 15-17 illustrate some system tools for managing winners. In FIG. 15, sweepstakes manager 210 views the potential winner's submitted affidavit to determine if the winner is eligible to receive the prize. Sweepstakes manager 210 may accept the affidavit or disqualify the entrant. As shown in FIG. 16, sweepstakes manager 210 may review entrant information online, during or after the sweepstakes period. The columns of information noted in the table of FIG. 16 has a direct correlation to the entry form questions specified in FIG. 5 and the information solicited in FIG. 10. If the entrants agree to be notified by sweepstakes manager 210 with regard to marketing opportunities, sweepstakes repository 200 can track response rates to all email sent (e.g., whether the entrant clicked on an advertisement link provided in the email), providing reports to sweepstakes manager 210 online as shown in FIG. 17. Sweepstakes repository 200 also provides interfaces for contestants and other to view lists of winners at the completion of the sweepstakes (not shown).

Several embodiments of the present invention are specifically illustrated and/or described herein. However, it will be appreciated that modifications and variations of the present invention are covered by the above teachings and within the purview of the appended claims without departing from the spirit and intended scope of the present invention.

What is claimed is:

1. A method for automating an online sweepstakes, comprising the steps of:
(a) providing to a user on a computer network a design interface for designing a sweepstakes form, the design interface associated with functionality for altering the appearance of the sweepstakes form based upon input from the user;
(b) receiving the input from the user via the computer network for altering the appearance of the sweepstakes form; and
(c) generating electronically a revised sweepstakes form based upon the input from the user.

2. The method according to claim 1, wherein the design interface includes a Web page resembling the sweepstakes form, the Web page associated with an editing button, the editing button linking to the functionality for altering the appearance of the sweepstakes form.

3. The method according to claim 2, wherein the functionality for altering the appearance of the sweepstakes form includes the substep of:
(d) prompting the user via the computer network to specify an attribute of the sweepstakes form.

4. The method according to claim 3, wherein the attribute of the sweepstakes form includes at least one of a question to be presented to the entrant on the sweepstakes form, a maximum permissible length of an entrant response in characters, whether a question to be presented to an entrant begins on a new line in the sweepstakes form, an instruction field associated with a question, and a type of question to be presented to the entrant.

5. The method according to claim 1, further comprising the steps of:
(d) receiving an indication from the user relating to sweepstakes parameters; and
(e) generating electronically a legal rule based upon the indication received from the user.

6. The method according to claim 1, further comprising the steps of:
(d) providing the user with a winner-drawing interface for randomly selecting winners of the online sweepstakes.

7. A computer arrangement for automating an online sweepstakes, comprising:
a communication device; and
a processor, the processor:
providing to a user via the communication device a design interface for designing a sweepstakes form, the design interface associated with functionality for altering the appearance of the sweepstakes form based upon input from the user,
receiving the input from the user via the communication device for altering the appearance of the sweepstakes form, and
generating a revised sweepstakes form based upon the input from the user.

8. The computer arrangement according to claim 7, wherein the design interface includes a Web page resembling the sweepstakes form, the Web page associated with an editing button, the editing button linking to the functionality for altering the appearance of the sweepstakes form.

9. The computer arrangement according to claim 8, wherein the processor prompts the user via the communication device to specify an attribute of the sweepstakes form.

10. The computer arrangement according to claim 9, wherein the attribute of the sweepstakes form includes at least one of a question to be presented to the entrant on the sweepstakes form, a maximum permissible length of an entrant response in characters, whether a question to be presented to an entrant begins on a new line in the sweepstakes form, an instruction field associated with a question, and a type of question to be presented to the entrant.

11. The computer arrangement according to claim 7,
wherein the processor receives via the communication device an indication from the user relating to sweepstakes parameters, and
wherein the processor generates a legal rule based upon the indication received from the user.

12. The computer arrangement according to claim 7, wherein the processor provides the user with a winner-drawing interface for randomly selecting winners of the online sweepstakes.

13. A method for integrating marketing tools with an online sweepstakes over a computer network, comprising the steps of:
(a) receiving contact information from an online sweepstakes entrant via an online entry form associated with the online sweepstakes; and
(b) providing a communication interface to a marketer, the communication interface using the contact information to allow the marketer to communicate with the online sweepstakes entrant over the computer network.

14. The method according to claim 13,
wherein the contact information includes an email address, and
wherein the marketer communicates with the online sweepstakes entrant via email.

15. The method according to claim 14, wherein the communication interface allows the marketer to track a response by the online sweepstakes entrant to an email message sent to the online sweepstakes entrant by the marketer.

16. A computer arrangement for integrating marketing tools with an online sweepstakes over a computer network, comprising:
a communication device; and
a processor, the processor:
receiving contact information via the communication device from an online sweepstakes entrant via an online entry form associated with the online sweepstakes, and
providing a communication interface to a marketer via the communication device, the communication interface using the contact information to allow the marketer to communicate with the online sweepstakes entrant over the computer network.

17. The computer arrangement according to claim 16,
wherein the contact information includes an email address, and
wherein the marketer communicates with the online sweepstakes entrant via email.

18. The computer arrangement according to claim 17, wherein the communication interface allows the marketer to track email response of the online sweepstakes entrant via the computer network.

19. A method for conducting an online sweepstakes over a computer network, comprising the steps of:
(a) providing to a user on a computer network a design interface for designing a sweepstakes form, the design interface associated with functionality for altering the appearance of the sweepstakes form based upon input from the user;
(b) receiving the input from the user via the computer network for altering the appearance of the sweepstakes form;
(c) generating electronically a revised sweepstakes form based upon the input from the user;
(d) receiving contact information from an online sweepstakes entrant via an online entry form associated with the online sweepstakes; and
(e) providing a communication interface to the user, the communication interface using the contact information to allow the user to communicate with the online sweepstakes entrant over the computer network.

20. The method according to claim 19, wherein the design interface includes a Web page resembling the sweepstakes form, the Web page associated with an editing button, the editing button linking to the functionality for altering the appearance of the sweepstakes form.

21. The method according to claim 20, wherein the functionality for altering the appearance of the sweepstakes form includes the substep of:
(f) prompting the user via the computer network to specify an attribute of the sweepstakes form.

22. The method according to claim 21, wherein the attribute of the sweepstakes form includes at least one of a question to be presented to the entrant on the sweepstakes form, a maximum permissible length of an entrant response in characters, whether a question to be presented to an entrant begins on a new line in the sweepstakes form, an instruction field associated with a question, and a type of question to be presented to the entrant.

23. The method according to claim 19, further comprising the steps of:
(f) receiving an indication from the user relating to sweepstakes parameters; and
(g) generating electronically a legal rule based upon the indication received from the user.

24. The method according to claim 19, further comprising the steps of:
(f) providing the user with a winner-drawing interface for randomly selecting winners of the online sweepstakes.

25. The method according to claim 19,
wherein the contact information includes an email address, and
wherein the marketer communicates with the online sweepstakes entrant via email.

26. The method according to claim 25, wherein the communication interface allows the marketer to track a response by the online sweepstakes entrant to an email message sent to the online sweepstakes entrant by the marketer.

27. A computer arrangement for conducting an online sweepstakes over a computer network, comprising:
a communication device; and
a processor, the processor:
providing to a user via the communication device a design interface for designing a sweepstakes form, the design interface associated with functionality for altering the appearance of the sweepstakes form based upon input from the user,
receiving the input from the user via the communication device for altering the appearance of the sweepstakes form,
generating a revised sweepstakes form based upon the input from the user,
receiving contact information via the communication device from an online sweepstakes entrant via an online entry form associated with the online sweepstakes, and
providing a communication interface to the user via the communication device, the communication interface using the contact information to allow the user to communicate with the online sweepstakes entrant over the computer network.

28. The computer arrangement according to claim 27, wherein the design interface includes a Web page resembling the sweepstakes form, the Web page associated with an editing button, the editing button linking to the functionality for altering the appearance of the sweepstakes form.

29. The computer arrangement according to claim 28, wherein the processor prompts the user via the communication device to specify an attribute of the sweepstakes form.

30. The computer arrangement according to claim 29, wherein the attribute of the sweepstakes form includes at least one of a question to be presented to the entrant on the sweepstakes form, a maximum permissible length of an entrant response in characters, whether a question to be presented to an entrant begins on a new line in the sweepstakes form, an instruction field associated with a question, and a type of question to be presented to the entrant.

31. The computer arrangement according to claim 27,
wherein the processor receives via the communication device an indication from the user relating to sweepstakes parameters, and
wherein the processor generates a legal rule based upon the indication received from the user.

32. The computer arrangement according to claim 27, wherein the processor provides the user with a winner-drawing interface for randomly selecting winners of the online sweepstakes.

33. The computer arrangement according to claim 27,
wherein the contact information includes an email address, and
wherein the user communicates with the online sweepstakes entrant via email.

34. The computer arrangement according to claim 33, wherein the communication interface allows the marketer to track a response by the online sweepstakes entrant to an email message sent to the online sweepstakes entrant by the marketer.

35. A machine-readable medium having stored thereon a plurality of executable instructions for automating an online sweepstakes, the plurality of instructions comprising instructions to:
(a) providing to a user on a computer network an interface for designing a sweepstakes form, the interface associated with functionality for altering the appearance of the sweepstakes form based upon input from the user;
(b) receiving the input from the user via the computer network for altering the appearance of the sweepstakes form; and
(c) generating electronically a revised sweepstakes form based upon the input from the user.

36. A machine-readable medium having stored thereon a plurality of executable instructions for integrating marketing tools with an online sweepstakes over a computer network, the plurality of instructions comprising instructions to:
(a) receiving contact information from an online sweepstakes entrant via an online entry form associated with the online sweepstakes; and
(b) providing a communication interface to a marketer, the communication interface using the contact information to allow the marketer to communicate with the online sweepstakes entrant over the computer network.

37. A machine-readable medium having stored thereon a plurality of executable instructions for conducting an online sweepstakes over a computer network, the plurality of instructions comprising instructions to:
(a) providing to a user on a computer network a design interface for designing a sweepstakes form, the design interface associated with functionality for altering the appearance of the sweepstakes form based upon input from the user;
(b) receiving the input from the user via the computer network for altering the appearance of the sweepstakes form;
(c) generating electronically a revised sweepstakes form based upon the input from the user;
(d) receiving contact information from an online sweepstakes entrant via an online entry form associated with the online sweepstakes; and
(e) providing a communication interface to the user, the communication interface using the contact information to allow the user to communicate with the online sweepstakes entrant over the computer network.
